(19) United States
(12) Patent Application Publication
(10) Pub. No.: US 2023/0006747 A1
(43) Pub. Date: Jan. 5, 2023

(54) METHODS AND DEVICES FOR HANDLING INTERFERENCE CAUSED BY ONE OR MORE WIRELESS TERMINALS SERVED BY A RADIO NETWORK NODE

(71) Applicant: Sony Group Corporation, Tokyo (JP)

(72) Inventors: Olof ZANDER, Södra Sandby (SE); Kun ZHAO, Malmö (SE); Erik BENGTSSON, Eslöv (SE); Fredrik RUSEK, Eslöv (SE); Jose FLORDELIS, Lund (SE)

(21) Appl. No.: 17/782,258

(22) PCT Filed: Dec. 7, 2020
(86) PCT No.: PCT/EP2020/084933

§ 371 Date: Jun. 3, 2022

(30) Foreign Application Priority Data
Dec. 20, 2019 (SE) 1951522-0

(51) Int. Cl. H04B 17/345; H04W 24/10

(52) U.S. Cl. CPC H04B 17/345; H04W 24/10; H04W 72/046

(57) ABSTRACT

A method is disclosed, performed in a radio network node, for handling interference caused by a plurality of wireless terminals served by the radio network node. The method comprises transmitting, to at least one wireless terminal of the plurality of wireless terminals served by the radio network node, a message indicative of a beam width restriction criterion to be applied to transmissions from the at least one wireless terminal.

The present disclosure pertains to the field of wireless communications. The present disclosure relates to a radio network node, a wireless terminal and methods performed therein for handling interference caused by one or more wireless terminals served by radio network node in a wireless communication system.

### BACKGROUND

In the 3rd Generation Partnership Project (3GPP), Device-to-Device (D2D) communication technology refers to a radio technology that enables wireless terminals to communicate directly with each other without routing the data through a network infrastructure, such as to a radio network node. D2D communication may e.g. be used for proximity-based services where devices detect their proximity and subsequently trigger different services, such as advertisements, local exchange of information, smart communication between vehicles, etc. Other applications may comprise public safety support, where devices may provide local connectivity in case of out-of-coverage or damage to the network infrastructure. D2D communication provides advantages such as enhanced coverage of the wireless communication network, improved spectrum efficiency (such as a more efficient use of available resources), reduced communication delay (also referred to as latency), as well as reduced energy consumption; however, it still has some shortcomings, such as security issues, mobility management, and handoff. Furthermore, D2D communication provides new challenges for interference management, security, mobility management and other aspects.

For higher frequency ranges, Frequency Range 2 (FR2), which comprises frequency bands from 24.25 GHz to 52.6 GHz, beam management is needed to establish a communication link. In order to e.g. reduce the risk of a failure during a handover, wireless terminals may use a wide antenna gain pattern for communication, such as wide beams, since this offers a good robustness to mobility procedures. By using a wide antenna gain pattern, the signal is transmitted over a wider area, which increases the likelihood that a receiver will receive the transmitted signal. However, a wide antenna gain pattern also increases the interference experienced by other wireless terminals that may overhear the transmitted signal that is not intended for these particular wireless terminals.

### SUMMARY

Accordingly, there is a need for devices and methods for handling interference caused by a plurality of wireless terminals served by a radio network node which mitigate, alleviate or address the shortcomings existing and provide a reduced interference situation in a wireless communication network without reducing robustness of mobility procedures.

A method is disclosed, performed in a radio network node, for handling interference caused by a plurality of wireless terminals served by the radio network node. The method comprises transmitting, to at least one wireless terminal of the plurality of the wireless terminals served by the radio network node, a message indicative of a beam width restriction criterion to be applied to transmissions from the at least one wireless terminal.

Further a method is disclosed, performed by a wireless terminal, for assisting a radio network node in handling interference, wherein the wireless terminal is served by the radio network node. The method comprises receiving, from the radio network node, a message indicative of a beam width restriction criterion. The method further comprises transmitting using a beam width in accordance with the beam width restriction criterion.

Further, a radio network node is provided, the radio network node comprising a memory circuitry, a processor circuitry, and a wireless interface, wherein the radio network node is configured to perform the method disclosed herein.

Further, a wireless terminal is provided, the wireless terminal comprising a memory circuitry, a processor circuitry, and a wireless interface, wherein the wireless terminal is configured to perform the method disclosed herein.

It is an advantage of the present disclosure that the radio network node is provided with a mechanism to control the transmit beam width of the wireless terminals during communication. The disclosed mechanism reduces the interference radiated in other directions than the one intended for communication. The radio network node can thereby instruct the wireless terminals to restrict their beam width during transmissions from the wireless terminals.

The radio network node can thus manage interference in the wireless communication system, such as in an area served by the radio network node, such as in a cell of the radio network node, in a flexible manner.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary wireless communication system comprising an exemplary network node and an exemplary wireless terminal according to this disclosure,

FIG. 2A is a diagram illustrating an exemplary wireless communication system operating according to an exemplary first beam width restriction criterion,

FIG. 2B is a diagram illustrating a wireless communication system operating according to an exemplary second beam width restriction criterion,

FIG. 3 is a flow-chart illustrating an exemplary method, performed by a radio network node, for handling interference caused by a plurality of wireless terminals served by the radio network node according to this disclosure,

FIG. 4 is a flow-chart illustrating an exemplary method, performed by a wireless terminal for assisting a radio network node in handling interference according to this disclosure,

FIG. 5 is a block diagram illustrating an exemplary radio network node according to this disclosure,

FIG. 6 is a block diagram illustrating an exemplary wireless terminal according to this disclosure, and

FIG. 7 is a signaling diagram illustrating an exemplary procedure for handling interference caused by one or more wireless terminals served by a radio network node according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

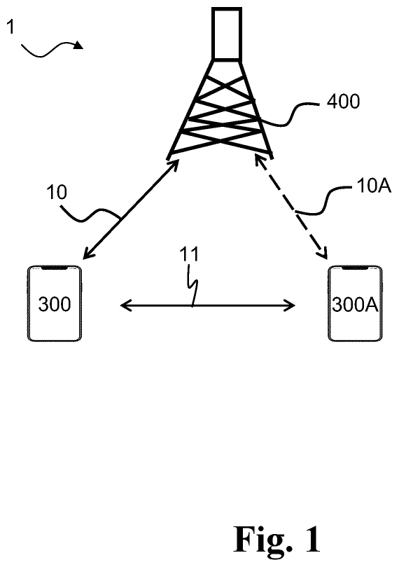

FIG. 1 is a diagram illustrating an exemplary wireless communication system 1 comprising an exemplary network node, such as a radio network node 400 and an exemplary wireless terminal 300 according to this disclosure.

As discussed in detail herein, the present disclosure relates to a wireless communication system 1 comprising a cellular system, e.g. a 3GPP wireless communication system. The wireless communication system 1 comprises a first wireless terminal 300 and/or a radio network node 400.

A radio network node disclosed herein refers to a radio access network node operating in the radio access network, such as a base station, an evolved Node B (eNB), a gNB or a transmission point (TRP).

The wireless communication system 1 described herein may comprise one or more wireless terminals 300, 300A, and/or one or more network nodes 400, such as one or more of: a base station, an eNB, a gNB, a TRP and/or an access point.

A wireless terminal may refer to a wireless device, a mobile device and/or a user equipment (UE).

The wireless terminal 300, 300A may be configured to communicate with the radio network node 400 via a wireless link (or radio access link) 10, 10A. The wireless terminal 300, 300A may further be configured to communicate using a private transmission (PT). The PT is a communication not transmitted via the radio network node and may e.g. be a wireless terminal communicating with another wireless terminal using D2D communication, such as via a side-link 11, or other communication such as radar transmission, beam sweeping. The beam sweeping could be for link setup or beam management where there may not be a known target device of the transmission.

One or more embodiments of this disclosure provide a method which allows the radio network node, such as a gNB, to set restrictions on how communication, such as PT, in a wireless communication network is to be performed, for reducing interference in the wireless communication system.

In some exemplary methods the radio network node may set and/or communicate a restriction to transmissions from wireless terminals being within a coverage area of the radio network node, such as being connected to the radio network node (either directly or indirectly for transmitting in a SL where the radio network node grants SL resources).

In some exemplary methods the radio network node may set the restrictions only to transmissions performed only in some resources in the time and frequency grid.

In some exemplary methods the radio network node may set the restriction only to devices connected to one or more specific beams of the radio network node (such as being associated to sub-areas within the coverage area of the radio network node).

In some exemplary methods a number of radio network node beams may be indirectly associated by the fact that they use the same Radio Access Channel (RACH) resource. The radio network node may set restrictions to wireless terminals associated to the beams using the same RACH resource.

In some exemplary methods the radio network node may set the restriction to an individual wireless terminal.

The method disclosed herein allows the radio network node to apply a restriction onto beam widths of transmit beams used by the one or more wireless terminals. The transmit beams may be used for PT (such as D2D communication or radar transmission (such as radar probing)) or for conventional transmissions to the radio network node via a radio interface between the wireless terminal and the radio network node, which interface may also be referred to as an Uu interface.

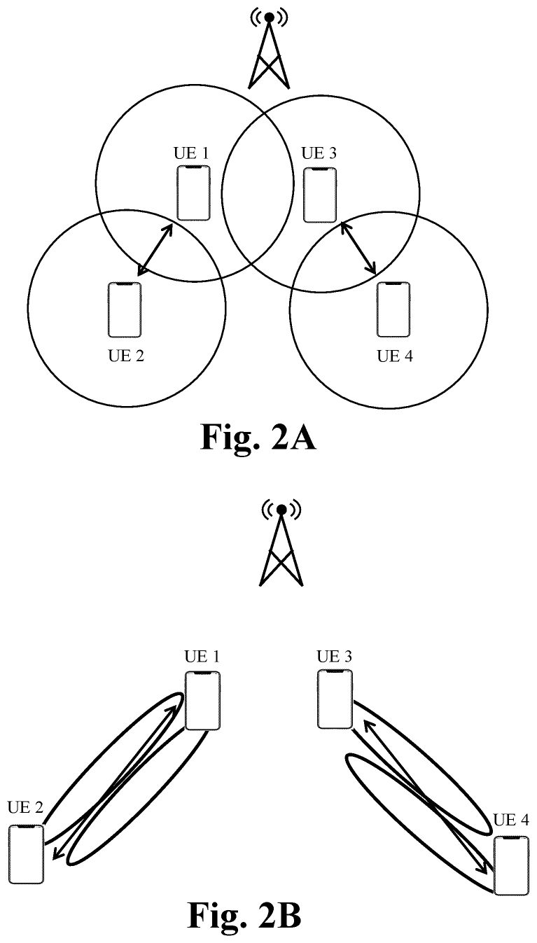

FIGS. 2A and 2B schematically illustrate the method according to one or more exemplary embodiments herein for a scenario where one or more of the plurality of wireless terminals are transmitting in D2D communication over a side-link. In FIG. 2A, a first wireless terminal (UE1) is communicating with a second wireless terminal (UE2) via a first side-link and a third wireless terminal (UE3) is communicating with a fourth wireless terminal (UE4) via a second side-link. The radio network node serves the wireless terminals by granting side-link resources. Initially, the wireless terminals may be communicating using a wide beam width, such as unrestricted beam widths, such as using a maximum beam width of the wireless terminals. The low directivity of the unrestricted beams may cause the transmit beams of the wireless terminals in the first and second side-links to interfere each other. The radio network node, such as the gNB, serving the wireless terminals monitors an interference scenario in the wireless communications network. The radio network node may monitor the interference scenario by (e.g. continuously) determining the interference situation in the wireless communications network. The radio network node may use existing mechanisms (e.g. according to a 3GPP standard) to request the wireless terminals to perform and report an interference situation. In some exemplary embodiments, the wireless terminal may also report a problem with interference without being requested to do so. Based on the reported interference the radio network node may determine whether the interference criterion is met. Once the monitored interference situation satisfies a triggering condition, such as upon meeting an interference criterion, the radio network node transmits a message indicating a beam width restriction criterion to the wireless terminals to be applied to the transmission from the wireless terminals. Based on the beam width restriction criterion the wireless terminals change the beam width of the transmit beam in accordance with the beam width restriction criterion. In the scenario disclosed in FIGS. 2A and 2B the beam width restriction criterion indicates that a narrower beam is to be used by the wireless terminals in order to reduce the interference experienced by other wireless terminals. The wireless terminals apply the new beam width restriction criterion, as shown in FIG. 1B, and perform the D2D communications using restricted beam widths directed towards the corresponding receiving wireless terminal of the side-link. By restricting a maximum permitted beam width, the directivity of the beams may be increased, and the transmissions can be directed towards the receiving wireless terminal in the side-link and away from other wireless terminals, thereby greatly reducing the interference between the side-links.

Although the example shown in FIGS. 2A and 2B discloses restricting the beam width from a wide beam to a narrow beam, the beam width restriction criterion may in some embodiments indicate that the wireless terminals are to use a wider beam than the beam width currently used by the terminals. This may e.g. be the case when the wireless terminals are transmitting with a narrow beam and the interference situation monitored by the radio network node improves (such as when the interference experienced by the radio network node or the wireless terminals decreases and falls below the interference threshold, such that the interference criterion is no longer fulfilled). In this case for example, the radio network node may signal a beam width restriction criterion indicating that the wireless terminals may use wider beams, such as e.g. a maximum beam width of the wireless terminal.

Examples of conditions triggering a transmission of the beam width restriction criterion may be one or more of the following:
An interference level experienced by the radio network node and/or one or more wireless terminals served by the radio network node being too high, according to a prescribed interference criterion, such as an interference threshold. The interference might be caused by either transmissions between the radio network node and the wireless terminals, or by transmissions between the wireless terminals. The interference experienced by the radio network node may originate from interference, which may also be referred to as over-hearing, between the receive beams of the radio network nodes in Multi User (MU) Uu scenarios. If multiple users use the same time and frequency resources the radio network node may separate them in the spatial domain (such as using different radio network node beams, e.g. gNB. beams). If the wireless terminals us wide beams an isolation between the beams may be poor. The radio network node may thus overhear uplink transmissions from a wireless terminal received on one radio network node beam on a second radio network node beam.
Similarly, in a PT scenario, the PT communication may cause interference for wireless terminals not involved in the PT link or for the radio network node. For the scenario where the wireless terminals experience interference, the wireless terminals may report the interference experienced by them (according to existing standard) and the radio network node may use the reported interference as a further degree-of-freedom for optimizing the interference situation in the wireless communication system, such as in a cell of the radio network node.
The number of active wireless terminals in the radio network node is too high, according to a prescribed criterion. The triggering may be based on a number of terminals connected to the radio network node and terminal mobility in combination with empirically developed experience, such as from deep learning algorithms.

The radio network node may associate a communication type (e.g. D2D communication, High-Reliability Low Latency Communication (HRLLC), enhanced Mobile Broadband (eMBB) communication, Ultra Reliable Low Latency Communication (URLLC), and/or Massive Machine Type Communications (mMTC)) with different transmit beam width restrictions.

The message indicating the beam width restriction criterion may be transmitted by the radio network node using broadcasted and/or direct signalling. In one or more exemplary embodiments herein, a default beam width restriction may be broadcasted from the radio network node to the wireless terminals. Further, beam width restrictions targeted to specific groups of wireless terminals may also be transmitted, e.g. using dedicated signalling.

The radio network node may associate the beam width restriction criterion with a maximum beam width. The wireless terminal may be configured with a set of different beam widths that may be used for transmissions. In order to avoid signalling absolute beam width numbers, since absolute numbers may not be understood by some wireless terminals and may imply a heavy signalling burden on the network, the radio network node may indicate relative beam widths, such as that the wireless terminals are to use the narrowest beam of the set of different beams or that the wireless terminals are to avoid the widest beam of the set of different beams. In some embodiments, a wireless terminal served by the radio network node, such as a wireless terminal served by a cell or a beam of the radio network node, may have a default setup that no beam width restrictions apply. By reducing the beam width at the wireless terminals, the interference (such as the overhearing) may be reduced.

The radio network node may signal an indication that some types of communication, such as during network procedures and/or during certain conditions, are excepted from the beam width restriction criterion. The types of communication that may be excepted from using a narrow beam width restriction criterion may e.g. comprise beam sweeps during beam management or during initial beam setup, and/or certain conditions, such as high wireless terminal mobility (UE mobility), such as wireless terminals travelling at a high speed. Other types of communication, such as transmission of data and/or control signalling (such as Physical Uplink Shared Channel (PUSCH) or Physical Uplink Control Channel (PUCCH) signalling) may however be required to use narrow beams when the beam width restriction criterion indicates a narrow beam width. This indication may be broadcasted to the wireless terminals, such as in a control signalling message, such as in a resource block comprising Synchronization signals, such as in a Synchronization Signal Block (SSB), or in a System Information, such as in the Master Information Block (MIB) contained in the Physical Broadcast Channel (PBCH), or in a System Information Block (SIB).

The wireless terminal may send a request to the radio network node that a communication needs to be performed with wide or narrow beam(s). The wireless terminal may e.g. request to use wide beams for high mobility wireless terminals, or whenever the wireless terminal broadcasts. In some scenarios the radio network node may have transmitted a beam width restriction criterion indicating that the wireless terminal is to use a pre-defined maximum beam width, but the wireless terminal is unable to perform properly when adhering to the restriction indicated by the beam width restriction criterion. The wireless terminal may thus request to the radio network node to use a more suitable beam width for the transmissions. The radio network node may respond to the request with an approval or a denial, depending on the interference situation. In some cases, one or more wireless terminals may have to broadcast emergency signals, such as during Vehicle-to-Vehicle (V2V) communication after an accident. In such a case, the wireless terminal may apply a different beam width than the beam width indicated by the beam width restriction criterion without awaiting approval from the radio network node.

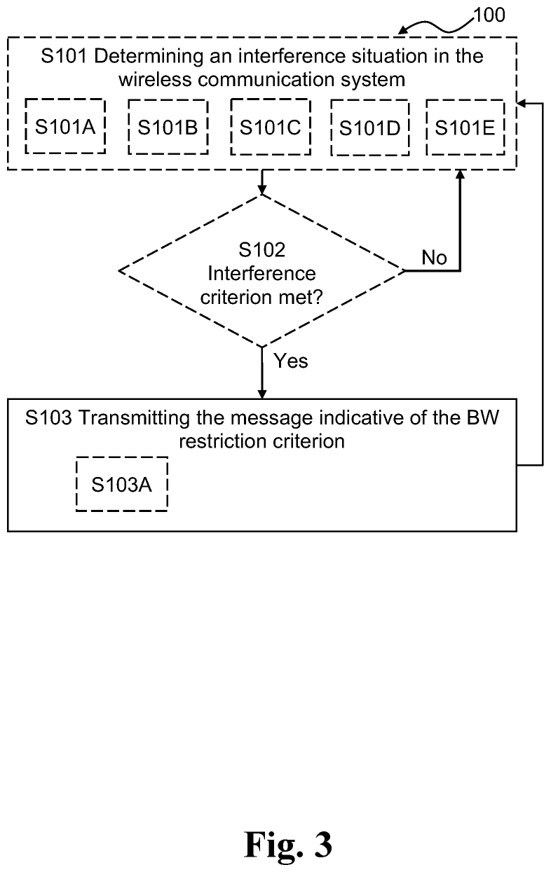

FIG. 3 shows a flow diagram of an exemplary method 100 performed in a radio network node, for handling interference caused by a plurality of wireless terminals served by the radio network node according to this disclosure. The method is performed when the radio network node for example identifies an interference situation and determines that an adaption of a beam width may be advantageous for the wireless terminal in order to change the interference situation in the radio communication system (as illustrated in relation to FIG. 2A-2B). The method may be performed going from either the scenario illustrated in FIG. 2A to the scenario illustrated in FIG. 2B or vice versa. The radio network node serves a plurality of wireless terminals, wherein the served wireless terminals have performed an attach procedure to the radio network node, such as to one or more cell(s) or beam(s) of the radio network node, and are in RRC connected or idle mode (such that the one or more wireless terminals can receive signalling from the radio network node). Initially, one or more of the plurality of wireless terminals may be transmitting using a beam width satisfying a first maximum beam width, which may form part of a first beam width restriction criterion. The first beam width restriction criterion may be an unrestricted beam width, e.g. allowing the wireless terminal to transmit with its widest beam or may be a restricted beam width. The first beam width restriction criterion may also indicate a restricted beam width to be used. The first beam width restriction criterion may be indicated (e.g. in a control signalling message) to the wireless terminals upon performing an attach procedure or a hand over procedure to the radio network node. In some exemplary methods the unrestricted beam width may be implicitly indicated to the wireless terminal by not signalling a beam width restriction criterion during the attach procedure or the hand over procedure. The transmissions from the one or more of the plurality of wireless terminals may be one or more of e.g. an up-link transmission, or a PT (such as a D2D transmission, e.g. a side-link transmission, and/or other transmissions, such as e.g. radar transmission).

In some embodiments, the method 100 comprises determining S101 (continuously) an interference situation in the wireless communication system. The interference situation may be an actual interference measured by the wireless terminals or an estimated interference based on a number of wireless terminals that are currently served by the radio network node. The interference criterion may be an interference threshold, such as an interference level (e.g. a maximum interference level) or a number of terminals (such as a maximum number of terminals). The interference criterion may be met e.g. when the interference situation exceeds the interference threshold, such as when the measured interference level exceeds the interference threshold. The interference level may e.g. be indicated by means of a Signal-to-Interference-plus-Noise Ratio (SINR), a bit error probability (BER), a block error probability (BLER), a Reference Signals Received Power (RSRP) in dedicated resources. or a similar metric which summarizes the probability of successfully decoding bits, packages, etc. transmitted over a communication link. The interference situation exceeding the interference threshold may be indicated by e.g. a measured SINR being below a SINR-threshold, a measured BER being above a BER-threshold, and/or a measured BLER being above a BLER-threshold. When the interference situation is above the interference threshold (which may be indicated by several different interference thresholds depending on selected interference measurement) the radio network node may indicate to the wireless terminal to use a narrow beam. When the interference situation is below the interference threshold the radio network node may indicate to the WD to use a wide beam (such as no restriction in beam width). Narrow and wide beams as used herein shall be interpreted as an indication of the beam widths relative to each other, wherein a first beam width is wider than a second beam width and the second beam width is narrower than the first beam width.

In one or more exemplary embodiments, the wireless terminal may be preconfigured with a plurality of different beam widths that the wireless terminal is configured to use, e.g. one beam width being narrower than the other. The radio network node may e.g. transmit a beam width restriction criterion indicating that the narrow or the wide beam should be used by the wireless terminal. The radio network node may however also transmit a beam width restriction criterion indicating a maximum beam width to be used for transmissions. The wireless terminal may, based on the maximum beam width, select a beam width that does not exceed the maximum beam width or may set the beam width for its transmission beam to the indicated maximum beam width.

In one or more exemplary embodiments, the determining S101 may comprise determining S102 whether the interference situation meets the interference criterion for transmitting the beam width restriction criterion. Upon determining that the interference criterion is met, the radio network node may transmit the beam width restriction criterion. Upon determining that the interference criterion is not met, the radio network node continues to determine S101 the interference situation in the network.

In one or more exemplary embodiments, the method may comprise, upon determining that the interference situation does not meet the interference criterion for the previously transmitted beam width restriction criterion, transmitting control signalling to the wireless terminals indicating that the one or more wireless terminals are to cease applying the previously transmitted beam width restriction criterion. In other words, the wireless terminals may be transmitting using a first beam width restriction criterion, the radio network node may determine that the interference situation meets an interference criterion and may transmit an indication to the wireless terminals to apply a second beam width restriction criterion. The radio network node then continues to determine, which may also be referred to as monitor, the interference situation. If the radio network node determines that the interference criterion for the second beam width restriction criterion is no longer met, it may indicate to the wireless terminals to cease applying the second beam width restriction criterion, which implies to switch back to the previous beam width restriction criterion (in this case the first beam width restriction criterion).

Upon determining that the interference situation does not meet the interference criterion, the radio network node may transmit control signalling to the wireless terminals indicating that the one or more wireless terminals are to cease applying the second beam width restriction criterion. If e.g. the interference situation was meeting the interference criterion, such that the network node transmits the second beam width restriction criterion to the wireless terminals, and the interference situation then changes so that the interference criterion is no longer met, the radio network node may transmit a message to the wireless terminals indicating that the second beam width restriction criterion is no longer to be applied. Hence, the wireless terminals may transmit using the previous beam width or may select any other beam width to transmit on. In other words, the radio network node may transmit a message to the wireless terminals indicating that the wireless terminal is to cease applying the second beam width restriction criterion.

In one or more exemplary embodiments, the determining S101 may comprise requesting S101A the one or more wireless terminals served by the radio network node to perform and report interference measurements. The determining S101 may further comprise receiving S101B measurement reports from the one or more wireless terminals served by the radio network node. If a first wireless terminal, such as a UE1, and a second wireless terminal, such as a UE2, communicate in side-link and a third wireless terminal reports interference, the radio network node may restrict the maximum beam width allowable for the first and the second wireless terminal, such as UE1 and UE2, in their side-link communication. When the wireless terminal switches beam width the wireless terminal may adapt the power level of the transmission. The wireless terminal may e.g. reduce the transmit-power when it switches to a narrower beam, and vice versa, so that the power received by the other wireless terminal in the side-link is constant.

In one or more exemplary embodiments, the determining S101 may comprise estimating S101C an interference level based on the number of wireless terminals served by the radio network node. The estimating S101C may comprise monitoring the number of wireless terminals (such as UEs) connected to the radio network node or to a set of beams, (such as one or more beams). This may also be referred to as wireless terminal intensity or UE intensity. The radio network node may, for a target deployment, correlate the number of terminals being served with the level of interference experienced, either based on simulations on a network level or based on measurements of interference levels in actual deployments.

In one or more exemplary embodiments, the determining S101 may comprise measuring S101D interference experienced by the radio network node and estimating S101E the interference level based on the measurements performed by the radio network node. In the uplink, the radio network node may measure the experienced interference level by, e.g., allowing PTs and/or allowing transmissions from all the wireless terminals in the network except the wireless terminal intended to be served in a certain time-frequency resource. Several radio network nodes may exchange estimated interference levels or might report the interference levels to a centralized network node, with the purpose of obtaining a more accurate picture of the interference situation in the network.

One or more of the above-mentioned method steps S101A-E may be combined for determining the interference situation. More generally, the radio network node may monitor the interference situation in the network, based on e.g. interference reports from wireless terminals, the number of wireless terminals served by the radio network node, and mobility of terminals, and decides based on the monitored interference situation whether a beam width restriction criterion is to be applied.

The method 100 comprises transmitting S103, to at least one of the plurality of wireless terminals served by the radio network node, a message indicative of a beam width restriction criterion to be applied to transmissions from the one or more of the plurality of wireless terminals served by the radio network node. The message indicative of the beam width restriction criterion is in some exemplary methods transmitted upon detecting that the determined interference situation in the wireless communication system meets an interference criterion. The beam width restriction criterion indicates to the one or more wireless terminals a beam width that they are allowed to use for transmissions (such as Uplink (UL), or PT (such as D2D or other transmissions, e.g. radar transmission) in the network, based on the current interference situation. The purpose of the message is to control the beam width used by the one or more wireless terminals for transmissions, in order to reduce interference experienced by the radio network node, other wireless terminals, and/or other radio network nodes. Upon receiving the message, the wireless terminals are to apply a beam width for transmissions, which beam width satisfies the beam width restriction criteria comprised in the message. For example, the beam width restriction criterion may indicate a maximum beam width to be used by the wireless terminal(s) for transmissions in UL, D2D and/or for other transmissions, such as radar. The beam width restriction criterion may in some exemplary embodiments indicate the maximum beam width as relative value, such as a level of restriction (e.g. unrestricted beam width or restricted beam width, and/or wide or narrow beam width), or such as a change in beam width (e.g. narrower or wider beam width). The beam width restriction criterion may in some exemplary embodiments indicate the maximum beam width as an absolute value, such as one or more maximum allowed beam width(s) (e.g. as a first maximum beam width or a second maximum beam width, and/or an n^{th} maximum beam width). In some exemplary methods the radio network node may receive a report of the beam widths and/or beam width levels supported by the wireless terminal from the wireless terminal, such as in a capability signalling. The beam widths and/or beam width levels supported by the wireless terminal may be received e.g. upon the wireless terminal performing an attachment procedure or a handover procedure to the radio network node. The beam width levels may be indicated as e.g. “narrowest beam width”, “narrow beam width”, “wide beam width” and/or “widest beam width”, wherein each beam width level corresponds to a specific beam width.

The beam width restriction criterion may indicate a second maximum beam width to be used for transmission. The first and the second maximum beam widths may be different. The first and second maximum beam widths may be indicated as absolute values or as values relative to each other. In other words, in some exemplary methods herein the wireless terminal may be configured with a plurality of beam widths. The plurality of beam widths may be indicated as e.g. “most narrow”, “second most narrow”, “third most narrow”, . . . , “third most wide”, “second most wide, and/or “most wide”, according to the mutual order of the beam widths. The first and second maximum beam widths may thus in some exemplary methods be indicated according to their respective indices, such as most narrow or most wide beam width.

The transmitted beam width restriction criterion may indicate a second maximum beam width to be used for transmission from the wireless terminals, which may form part of a second beam width restriction criterion. The first and the second maximum beam widths, or beam width restriction criterion, may be different. The first maximum beam width depends on the current state of the transmission. If there is a high level of interference, the wireless terminals may be requested or allowed to transmit using a narrow (or restricted) beam. If there is a low level of interference, the wireless terminals may be requested to transmit using a wide (or unrestricted) beam. The second maximum beam width is different than the first maximum beam width. If the first maximum beam width is a wide beam the second maximum beam width may be a narrower beam. If the first maximum beam width is a narrow beam then the second maximum beam width is a wide beam. In some embodiments the radio network node may define more than two different beam width restriction criteria, which it can request the wireless terminals to use. The more than two different beam width restriction criteria may e.g. indicate the beam widths as relative values (such as “narrowest beam width”, “narrower beam width”, “wider beam width” and/or “widest beam width”) or as absolute values of the maximum beam widths of each of the one or more beam width restriction criterion.

The transmitting S103 of the message indicative of the beam width restriction criterion may be performed upon determining that the estimated interference level meets the interference criterion, such as when the monitored number of connected wireless terminals exceeds a terminal threshold and/or the estimated interference level exceeds an interference level threshold.

The transmitting S103 of the message may however also be triggered by other events, such as of the radio network nodes own volition, (e.g. for improving mobility procedures of the wireless terminals). The transmitting S103 of the message indicative of the beam width restriction criterion may comprise transmitting S103A a control signalling message comprising the beam width restriction criterion. In other words, the beam width restriction criterion may be transmitted in a control signalling message.

The radio network node may apply different beam width restriction criteria on different types of communications transmitted by the one or more wireless terminals. The types of communications may e.g. be D2D communication, High-Reliability Low Latency Communication (HRLLC), enhanced Mobile Broadband (eMBB) communication, Ultra Reliable Low Latency Communication (URLLC), and/or Massive Machine Type Communications (mMTC). The radio network node may also indicate, to the wireless terminals, that a certain type of transmissions is excepted from the beam width restriction criterion. The beam width restriction criterion may e.g. comprise an indication of the type of communication the beam width restriction criterion applies to.

The control signalling message sent to the one or more wireless terminals may comprise an indication of the communications type that the beam width restriction criterion applies to. Hence, the transmitting S103 of the message indicative of the beam width restriction criterion may comprise transmitting an indication of the communications type that the beam width restriction criterion applies to. The control signalling transmitted by the radio network node may further comprise exceptions from the beam width restriction criterion, such as communication types that the beam width restriction criterion is not to be applied to.

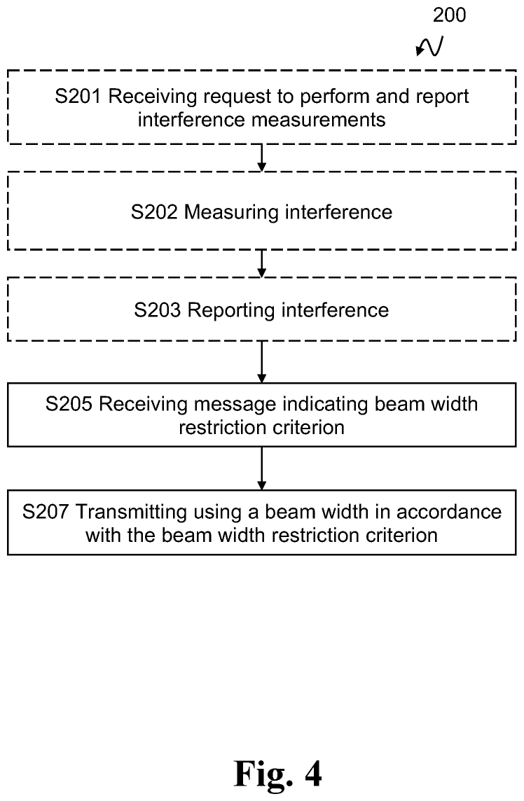

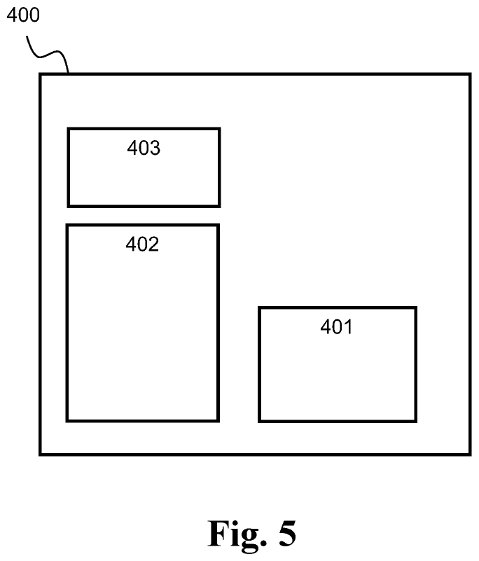

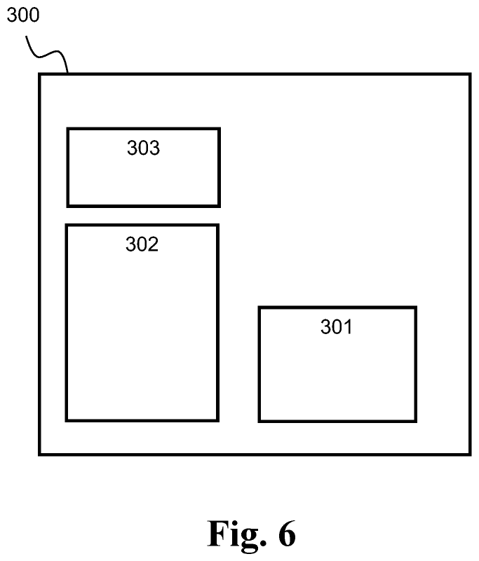

FIG. 4 shows a flow diagram of an exemplary method 200 performed by a wireless terminal, for assisting a radio network node in handling interference, wherein the wireless terminal is served by the radio network node according to the disclosure (e.g. radio network node 400 of FIGS. 1, and 5). Initially the wireless terminal (e.g. wireless terminal 300 of FIGS. 1, and 6) may transmit or may be configured to transmit with a first beam width. The first beam width may satisfy a first maximum beam width, which may form part of a first beam width restriction criterion.

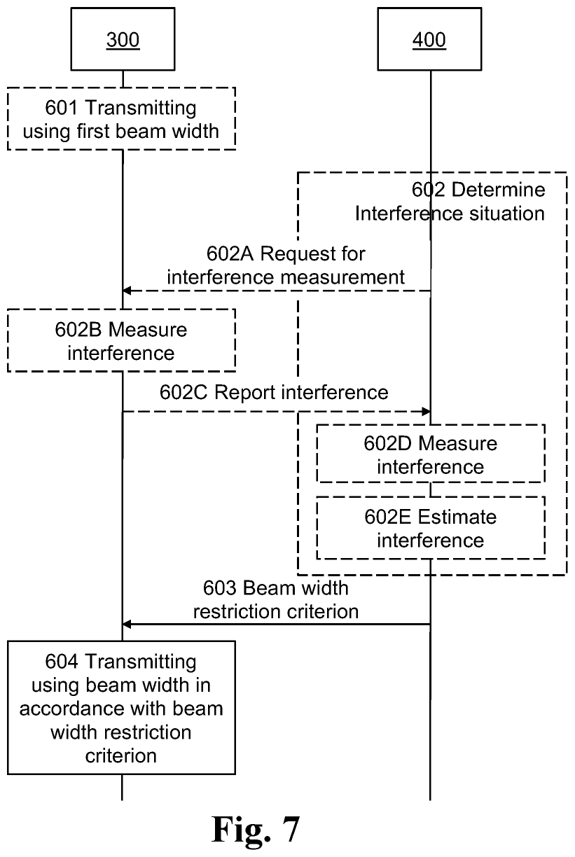

The method 200 may comprise receiving S201, from the radio network node, a request to perform and report interference measurements. This step S201 corresponds to e.g. the step S101A of FIG. 3 and e.g. step 602A of FIG. 7.

The method 200 may further comprise measuring S202 interference experienced. The wireless terminal may measure the interference experienced e.g. by measuring the SINR, the BER, the BLER or the RSRP. This step S202 corresponds to the step 602B of FIG. 7.

The method 200 may further comprise sending S203, to the radio network node, a report of the experienced interference. This step S203 corresponds to the step S101B of FIG. 3 and step 602C of FIG. 7.

The method 200 comprises receiving S205, from the radio network node, a message indicative of a beam width restriction criterion. The beam width restriction criterion may indicate a maximum beam width to be used for transmissions. Initially, the wireless terminal may transmit using a first maximum beam width, and the beam width restriction criterion may indicate a second maximum beam width to be used for transmission. The first and the second maximum beam widths may be different. The receiving S205 may comprise receiving the indication in a control signalling message from the radio network node. The receiving S205 may comprise receiving the indication via broadcasted or via dedicated signalling from the radio network node. The receiving S205 may further comprise receiving an indication of the communication type that the beam width restriction criterion applies to. In some embodiments herein, the wireless terminal may be pre-configured with a plurality of beam width levels, which plurality of beam width levels may be indicated as e.g. “narrowest beam width”, “narrow beam width”, “wide beam width” and/or “widest beam width”, each level corresponding to a specific beam width. The beam width restriction criterion received from the radio network node may indicate e.g. that the wireless terminals are to use “wide beam width” for the transmission. Based on the received indication the wireless terminal may perform transmission using the pre-configured beam width corresponding to “wide beam width”. The beam widths and/or beam width levels supported by the wireless terminal may in some exemplary methods be reported to the radio network node by the wireless terminal, such as in a capability signalling. The beam widths and/or beam width levels supported by the wireless terminal may be reported e.g. upon performing an attachment procedure or a handover procedure. This step S205 corresponds to step S103 of FIG. 3 relating to the radio network node and step 603 of FIG. 7.

The method 200 comprises transmitting S207 using a beam width in accordance with the beam width restriction criterion. This step S207 corresponds to e.g. step 604 of FIG. 7. For example, the wireless terminal transmits in S207 one or more signals using the beam width complying with the beam width restriction criterion. The transmission transmitted in S207 may be a PT transmission and/or a transmission to the radio network node (such as via a Uu interface).

FIG. 5 shows a block diagram of an exemplary radio network node 400 according to the disclosure. The radio network node 400 comprises a memory circuitry 401, a processor circuitry 402, and a wireless interface 403. The radio network node 400 may be configured to perform any of the methods disclosed in FIG. 3. In other words, the radio network node 400 may be configured for handling interference caused by a plurality of wireless terminals served by the radio network node.

The radio network node 400 is configured to communicate with a wireless terminal, such as the wireless terminal 300 disclosed herein, using a wireless communication system.

The wireless interface 403 is configured for wireless communications via a wireless communication system, such as a 3GPP system, such as a 3GPP system supporting millimetre-wave communications, such as millimetre-wave communications in licensed bands, such as device-to-device millimetre-wave communications in licensed bands, or un-licensed bands (such as multi-fire).

The radio network node 400 is configured to transmit, e.g. via the wireless interface 403, to at least one of the plurality of wireless terminals served by the radio network node, a message indicative of a beam width restriction criterion to be applied to transmissions from the one or more of the plurality of wireless terminals served by the radio network node.

The processor circuitry 402 is optionally configured to perform any of the operations disclosed in FIG. 3 (such as any one or more of S101, S101A, S101B, S101C, S101D, S101E, S103A) and/or any of the operations disclosed in FIG. 7 relating to the radio network node 400 (such as any one or more of 602, 602A, 602C, 602D, 602E, 602F). The operations of the radio network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the radio network node 400 may be considered a method that the radio network node 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 5). The memory circuitry 401 is considered a non-transitory computer readable medium.

The memory circuitry 401 may be configured to store beam width restriction criterion and measurement results in a part of the memory.

FIG. 6 shows a block diagram of an exemplary wireless terminal 300 according to the disclosure. The wireless terminal 300 comprises a memory circuitry 301, a processor circuitry 302, and a wireless interface 303. The wireless terminal 300 may be configured to perform any of the methods disclosed in FIG. 4. In other words, the wireless terminal 300 may be configured for assisting a radio network node in handling interference.

The wireless terminal 300 is configured to communicate with a network node, such as the radio network node 400 disclosed herein, or with a further wireless terminal, such as the wireless terminal 300A disclosed herein, using a wireless communication system. The wireless interface 303 is configured for wireless communications via a wireless communication system, such as a 3GPP system, such as a 3GPP system supporting millimetre-wave communications, such as millimetre-wave communications in licensed bands, such as device-to-device millimetre-wave communications in licensed bands, or un-licensed bands (such as multi-fire).

The wireless terminal 300 is configured to receive, e.g. via the wireless interface 303, from the radio network node, a message indicative of a beam width restriction criterion. The wireless terminal 300 is further configured to transmit, e.g. via the wireless interface 303, using a beam width in accordance with the beam width restriction criterion. The wireless terminal 300 is further configured to transmit, e.g. via the wireless interface 303, one or more signals using the beam width complying with the beam width restriction criteria.

The processor circuitry 302 is optionally configured to perform any of the operations disclosed in FIG. 4 (such as any one or more of S201, S202, S203) and/or any of the operations disclosed in FIG. 7 relating to the wireless terminal 300 (such as any one or more of 601, 602A, 602B, 602C). The operations of the wireless terminal 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless terminal 300 may be considered a method that the wireless terminal 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 6). The memory circuitry 301 is considered a non-transitory computer readable medium.

The memory circuitry 301 may be configured to store e.g. predefined beam widths to be used, a beam width restriction criterion and/or measurement results in a part of the memory.

FIG. 7 is a signaling diagram illustrating an exemplary message exchange between one or more exemplary wireless terminals 300 and an exemplary radio network node 400 during an exemplary procedure for handling interference caused by a plurality of wireless terminals served by the radio network node.

Initially, the one or more wireless terminals 300 may be transmitting 601 with a first beam width, such as according to a first beam width restriction criterion.

The radio network node 400 may determine 602, which may also be referred to as monitor, an interference situation in the wireless communication system. This step 602 corresponds to step S101 of FIG. 3.

In one or more exemplary embodiments herein, the determining 602 may comprise the radio network node 400 transmitting 602A a request for interference measurement to the wireless terminal 300. The request may be transmitted by broadcasting the request to the one or more wireless terminals served by the radio network node 400. This step 602A corresponds to step S101A of FIG. 3 and to step S201 of FIG. 4. The determining 602 may further comprise the one or more wireless terminals 300 measuring 602B the interference experienced by the one or more wireless terminals 300. This step 602B corresponds to step S202 of FIG. 4. The one or more wireless terminals 300 may then report S6020 the interference measured to the radio network node 400. This step 602C corresponds to step S203 of FIG. 4 and to step S101B of FIG. 3.

In one or more exemplary embodiments herein, the determining 602 may comprise the radio network node 400 measuring 602D the interference experienced by the radio network node 400. This step 602D corresponds to step S101D of FIG. 3.

Based on the interference measurements performed by the one or more wireless terminals 300, the radio network node 400 and/or the number of wireless terminals served by the radio network node 400, the radio network node 400 may estimate 602E the interference situation in the wireless communications network. This step 602E is similar to the steps S101C or S101E of FIG. 3.

The radio network node 400 transmits a message indicating a beam width restriction criterion to the one or more wireless terminals 300. The beam width restriction criterion to be applied to transmissions from one or more of the wireless terminals 300 served by the radio network node 400. The message indicating the beam width restriction criterion may be broadcasted to the one or more wireless terminals 300 or may be transmitted to the one or more wireless terminals 300 using direct signaling. This step 603 corresponds to the step S103 of FIG. 3.

The one or more wireless terminals 300 transmit using a beam width in accordance with the beam width restriction criterion indicated in the message. This step 604 corresponds to the step S207 of FIG. 4.

Embodiments of methods and products (radio network node and wireless terminal) according to the disclosure are set out in the following items:
Item 1. A method, performed in a radio network node, for handling interference caused by a plurality of wireless terminals served by the radio network node, the method comprising:
   transmitting (S103), to at least one wireless terminal of the plurality of wireless terminals served by the radio network node, a message indicative of a beam width restriction criterion to be applied to transmissions from at least one wireless terminal.
Item 2. The method according to Item 1, wherein the method comprises determining (S101) an interference situation in the wireless communication system, and wherein the message indicative of the beam width restriction criterion is transmitted upon detecting that the determined interference situation in the wireless communication system meets an interference criterion.
Item 3. The method according to Item 1 or 2, wherein the transmitting (S103) the message indicative of the beam width restriction criterion comprises transmitting (S103A) a control signalling message comprising the beam width restriction criterion.
Item 4. The method according to any one of the Items 2 to 3, wherein the determining (S101) comprises requesting (S101A) the one or more wireless terminals served by the radio network node to perform and report interference measurements and receiving (S101B) measurement reports from the one or more wireless terminals served by the radio network node.
Item 5. The method according to any of the Items 2 to 4, wherein the determining (S101) comprises estimating (S101C) an interference level based on the number of wireless terminals served by the radio network node, wherein the message indicative of the beam width restriction criterion is transmitted upon determining that the estimated interference level meets the interference criterion.
Item 6. The method according to any of the Items 2 to 5, wherein the determining (S101) comprises measuring (S101D) interference experienced by the radio network node and estimating (S101E) the interference level based on the measurements performed by the radio network node, wherein the message indicative of the beam width restriction criterion is transmitted upon determining that the estimated interference level meets the interference criterion.
Item 7. The method according to any of the Items 1 to 6, wherein the radio network node applies different beam width restriction criterion on different types of communications transmitted by the one or more wireless terminals.
Item 8. The method according to Item 7 when dependent on Item 3, wherein the control signalling sent to the one or more wireless terminals comprises an indication of the communications type that the beam width restriction criterion applies to.
Item 9. The method according to any one of the Items 1 to 8, wherein the beam width restriction criterion indicates a maximum beam width to be used for transmissions.
Item 10. The method according to any one of the previous Items, wherein one or more of the plurality of wireless terminals are initially transmitting using a first maximum beam width and wherein the beam width restriction criterion indicates a second maximum beam width to be used for transmission.
Item 11. The method according to Item 10, wherein the first and the second maximum beam widths are different.
Item 12. The method according to Item 10 or 11, wherein the first and second maximum beam widths are indicated as absolute values or as values relative to each other.
Item 13. The method according to any of the previous Items, wherein the transmissions from the one or more of the plurality of wireless terminals is one or more of an up-link transmission and/or a side-link transmission.
Item 14. A method performed by a wireless terminal, for assisting a radio network node in handling interference, wherein the wireless terminal is served by the radio network node, the method comprising:
   receiving (S205), from the radio network node, a message indicative of a beam width restriction criterion, and
   transmitting (S207) using a beam width in accordance with the beam width restriction criterion.
Item 15. The method according to Item 14, wherein the beam width restriction criterion indicates a maximum beam width to be used for transmissions.
Item 16. The method according to any one of the Items 14 or 15, wherein the wireless terminal is initially transmitting using a first maximum beam width and wherein the beam width restriction criterion indicates a second maximum beam width to be used for transmission.
Item 17. The method according to Item 16, wherein the first and the second maximum beam widths are different.
Item 18. The method according to any one of the Items 14 to 17, wherein the receiving (S205) comprises receiving the indication in a control signalling message from the radio network node.
Item 19. The method according to any one of the Items 14 to 18, wherein the receiving (S205) comprises receiving the indication via a broadcasted or via a dedicated signalling from the radio network node.
Item 20. The method according to any one of the Items 14 to 19, wherein the wireless terminal further receives, from the radio network node, an indication of the communication type that the beam width restriction criterion applies to.
Item 21. The method according to any one of the Items 14 to 20, wherein the method further comprises
   receiving (S201), from the radio network node, a request to perform and report interference measurements,
   measuring (S202) interference experienced,
   sending (S203), to the radio network node, a report of the experienced interference.
Item 22. A radio network node comprising a memory circuitry, a processor circuitry, and a wireless interface, wherein the radio network node is configured to perform any of the methods according to any of Items 1-13.
Item 23. A wireless terminal comprising a memory circuitry, a processor circuitry, and a wireless interface, wherein the wireless terminal is configured to perform any of the methods according to any of Items 14-21.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that FIGS. 1-7 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented.

Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed in a radio network node, for handling interference caused by a plurality of wireless terminals served by the radio network node, the method comprising:
transmitting, to at least one wireless terminal of the plurality of wireless terminals served by the radio network node, a message indicative of a beam width restriction criterion to be applied to transmissions from the at least one wireless terminal, wherein the at least one wireless terminal is initially transmitting using a first maximum beam width and wherein the beam width restriction criterion indicates a second maximum beam width to be used for transmission.

2. The method according to claim 1, wherein the method comprises determining an interference situation in the wireless communication system, and wherein the message indicative of the beam width restriction criterion is transmitted upon detecting that the determined interference situation in the wireless communication system meets an interference criterion.

3. The method according to claim 1, wherein the transmitting the message indicative of the beam width restriction criterion comprises transmitting a control signalling message comprising the beam width restriction criterion.

4. The method according to claim 2, wherein the determining comprises requesting the one or more wireless terminals served by the radio network node to perform and report interference measurements and receiving measurement reports from the one or more wireless terminals served by the radio network node.

5. The method according to claim 2, wherein the determining comprises estimating an interference level based on the number of wireless terminals served by the radio network node, wherein the message indicative of the beam width restriction criterion is transmitted upon determining that the estimated interference level meets the interference criterion.

6. The method according to claim 2, wherein the determining comprises measuring interference experienced by the radio network node and estimating the interference level based on the measurements performed by the radio network node, wherein the message indicative of the beam width restriction criterion is transmitted upon determining that the estimated interference level meets the interference criterion.

7. The method according to claim 1, wherein the radio network node applies different beam width restriction criterion on different types of communications transmitted by the one or more wireless terminals.

8. The method according to claim 7, wherein the transmitting the message indicative of the beam width restriction criterion comprises transmitting a control signalling message comprising the beam width restriction criterion, and wherein the control signalling sent to the one or more wireless terminals comprises an indication of the communications type that the beam width restriction criterion applies to.

9. The method according to claim 1, wherein the beam width restriction criterion indicates a maximum beam width to be used for transmissions.

10. The method according to claim 1, wherein one or more of the plurality of wireless terminals are initially transmitting using a first maximum beam width and wherein the beam width restriction criterion indicates a second maximum beam width to be used for transmission.

11. The method according to claim 10, wherein the first and second maximum beam widths are indicated as absolute values or as values relative to each other.

12. The method according to claim 10, wherein the first and second maximum beam widths are indicated as absolute values or as values relative to each other.

13. The method according to claim 1, wherein the transmissions from the one or more of the plurality of wireless terminals is one or more of an up-link transmission and/or a side-link transmission.

14. A method performed by a wireless terminal, for assisting a radio network node in handling interference, wherein the wireless terminal is served by the radio network node, the method comprising:
receiving, from the radio network node, a message indicative of a beam width restriction criterion, and
transmitting using a beam width in accordance with the beam width restriction criterion
wherein the wireless terminal is initially transmitting using a first maximum beam width and wherein the beam width restriction criterion indicates a second maximum beam width to be used for transmission.

15. The method according to claim 14, wherein the beam width restriction criterion indicates a maximum beam width to be used for transmissions.

16. The method according to claim 14, wherein the first and the second maximum beam widths are different.

17. The method according to claim 14, wherein the receiving comprises receiving the indication in a control signalling message from the radio network node.

18. The method according to claim 14, wherein the receiving comprises receiving the indication via a broadcasted or via a dedicated signalling from the radio network node.

19. The method according to claim 14, wherein the wireless terminal further receives, from the radio network node, an indication of the communication type that the beam width restriction criterion applies to.

20. The method according to claim 14, wherein the method further comprises
receiving, from the radio network node, a request to perform and report interference measurements,
measuring interference experienced,
sending, to the radio network node, a report of the experienced interference.

21-22. (canceled)
